(19) United States
(12) Patent Application Publication
(10) Pub. No.: US 2024/0264133 A1
(43) Pub. Date: Aug. 8, 2024

(54) SEPARATION CHROMATOGRAPHY SUPPORTING DEVICE, SEPARATION CHROMATOGRAPHY APPARATUS, AND SEPARATION CHROMATOGRAPHY METHOD

(71) Applicant: Yamazen Corporation, Osaka (JP)

(72) Inventor: Kihachiro OKURA, Osaka (JP)

(21) Appl. No.: 18/163,406

(22) Filed: Feb. 2, 2023

(51) Int. Cl. G01N 30/95; B01D 15/16; G01N 30/90

(52) U.S. Cl. CPC G01N 30/95; B01D 15/166; G01N 30/90

(57) ABSTRACT

Provided is a separation chromatography supporting device capable of predicting, using a result of thin-layer chromatography or column chromatography, a result of liquid chromatography for a wide range of compounds with high accuracy and setting an optimum separation condition. The separation chromatography supporting device includes a calculation formula acquisition unit, and provides information related to separation in column chromatography based on an actually measured value of an Rf value when a mixed solvent having a mixing ratio B of two specific types of solvents measured by thin-layer chromatography or liquid chromatography is used. The calculation formula acquisition unit acquires a₁ in a relational formula of

$$Rf = {a}_{1} B + {b}_{1} \qquad ( 1 )$$

or a₂ in a relational formula of

$$log {k}^{′} = {a}_{2} log B + {b}_{2} \qquad ( 2 )$$

$$( where retention ratio : {k}^{′} = ( {t}_{R} - {t}_{0} ) / {t}_{0} \qquad ( 3 )$$

solvent ratio: B) based on B and Rf that are actually measured values as one measurement result by TLC.

### CROSS-REFERENCE TO RELATED APPLICATIONS

Japanese Application No. 2021-169841 filed Oct. 15, 2021 is incorporated herein by reference in its entirety.

### FIELD OF THE PRESENT INVENTION

The present invention relates to a separation chromatography supporting device, a separation chromatography apparatus, and a separation chromatography method.

### BACKGROUND OF THE PRESENT INVENTION

In liquid chromatography, a solution in which a sample is dissolved is caused to pass through a stationary phase with which a column is filled. At this time, time for components in the sample introduced into the column to pass through the column differs due to interaction with the stationary phase, affinity with a mobile phase, and the like, and thus the components are separated at time points of being discharged from the column. A substance having a strong interaction with the stationary phase or a weak affinity with the mobile phase remains in the column for a long time and is slowly discharged from the column.

In such liquid chromatography, selection of a type of a solvent and selection of a column size are necessary, and an elution time of a sample is closely related to these conditions. Therefore, when a test result can be predicted before actual liquid chromatography is performed, efficiency of an experiment can be improved.

There is thin-layer chromatography (TLC) performed based on the same principle as that of the liquid chromatography described above. In the thin-layer chromatography, a sample is dropped on a substance used as a stationary phase in a column formed into a thin layer, and the thin layer is immersed in an eluent serving as a mobile layer. Then, mobility Rf of the sample with respect to the eluent can be obtained by an action of suctioning up the sample when the eluent is suctioned up into the thin layer due to capillary action (FIGS. 4 and 5). In this way, it is known that there is a correlation between the mobility Rf obtained by TLC performed with an eluent having any solvent ratio and an elution time in the liquid chromatography.

The present applicant filed JP2003-240765A (PTL 1), JP2017-32403A (PTL 2), JP2017-125686A (PTL 3), and JP2007-3398A (PTL 4) for a liquid chromatography control device that efficiently performs liquid chromatography by predicting a result of the liquid chromatography in advance based on a result of TLC using such a correlation between the result of TLC and a separation degree of the liquid chromatography.

In PTL 1, a relationship between the mobility Rf and a solvent mixing ratio (B/A) is approximated based on a linear function. With such approximation, the result of the liquid chromatography can be predicted based on the result of TLC, and this is fairly useful for industries. However, the higher accuracy between a result prediction of separation chromatography and an actual separation result, the more preferable. With higher accuracy, it is possible to set optimum conditions and perform separation liquid chromatography. Therefore, a separation chromatography supporting device capable of attaining higher accuracy is more preferable.

In consideration of such a point, the present inventor further advanced a function of liquid chromatography, accurately predicted an elution time based on PTL 1, and studied a system capable of setting conditions that always enable optimum separation.

### BRIEF SUMMARY OF THE PRESENT INVENTION

In view of the above description, an object of the present invention is to provide a method capable of predicting a result of liquid chromatography for a wide range of compounds with high accuracy using a result of thin-layer chromatography or column chromatography and setting an optimum separation condition. That is, an object of the present invention is to provide a liquid chromatography method capable of always performing efficient liquid chromatography under an optimum condition.

The present invention provides a separation chromatography supporting device including a calculation formula acquisition unit. The separation chromatography supporting device provides information related to separation in column chromatography based on an actually measured value of an Rf value when a mixed solvent having a mixing ratio B of two specific types of solvents measured by thin-layer chromatography or liquid chromatography is used, and the calculation formula acquisition unit acquires a₁ in a relational formula of

$$Rf = {a}_{1} B + {b}_{1} \qquad ( 1 )$$

or a₂ in a relational formula of

$$log {k}^{′} = {a}_{2} log B + {b}_{2} \qquad ( 2 )$$

$$( where retention ratio : {k}^{′} = ( {t}_{R} - {t}_{0} ) / {t}_{0} \qquad ( 3 )$$

solvent ratio: B) based on B and Rf that are actually measured values as one measurement result by TLC.

It is preferable that the separation chromatography supporting device described above further includes a calculation formula acquisition unit configured to actually measure a relationship between Rf values of plural types of compounds and a mixing ratio B of a solvent for a combination of two specific types of solvents. The calculation formula acquisition unit is obtained based on data obtained in the actual measurement. The present invention also provides a separation chromatography apparatus including the separation chromatography supporting device described above.

The present invention also provides a separation chromatography method including: a step (1) of performing thin-layer chromatography on a compound to be separated in a mixed solvent having a mixing ratio B of two specific types of solvents: a step (2) of inputting an Rf value and the mixing ratio B obtained in step (1) into the separation chromatography supporting device according to claim 1; a step (3) of acquiring, based on data input in step (2), a₁ or a₂ in a relational formula of

$$Rf = {a}_{1} B + b \qquad ( 1 )$$

$$or$$

$$log {k}^{′} = {a}_{2} log B + b \qquad ( 2 )$$

$$( where retention ratio : {k}^{′} = ( {t}_{R} - {t}_{0} ) / {t}_{0} ) ; \qquad ( 3 )$$

a step (4) of determining a gradient condition for separation chromatography based on the relational formula; and a step (5) of performing chromatography according to the gradient condition determined in step (4).

Using the separation chromatography supporting device according to the present invention, it is possible to predict a result of chromatography with higher accuracy, thereby improving efficiency of a separation operation in a chemical experiment.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The nature and mode of operation of the present invention will now be more fully described in the following detailed description of the present invention taken with the accompanying drawing figures, in which:

FIG. 1 is a diagram showing a relationship between actually measured values of an Rf value and a solvent mixing ratio B for plural types of compounds;

FIG. 2 is a diagram showing a relationship between B and a slope a at a specific Rf value in a relational formula as shown in FIG. 1:

FIG. 3 is a diagram showing a relationship between an intercept and Rf in the relationship between B and the slope a at the specific Rf value as shown in FIG. 2:

FIG. 4 is a diagram showing a gradient:

FIG. 5 is a perspective view showing a device that performs TLC:

FIGS. 6A and B are schematic views of a silica gel thin-layer plate when TLC is performed, in which FIG. 6A shows a state before TLC and FIG. 6B shows a state after TLC:

FIG. 7 is a schematic view showing a liquid chromatography apparatus to which the present invention is applied:

FIG. 8 shows an elution curve obtained based on a calculation formula obtained by a method according to the present invention; and

FIG. 9 shows an elution curve obtained based on a calculation formula obtained by a method in the related art.

### DETAILED DESCRIPTION OF THE PREFERRED EMBODIMENT

A separation chromatography supporting device according to the present invention can predict a behavior when separation chromatography is performed on a compound to be separated based on a result of TLC, and can find an optimum chromatography condition and accurately predict a result of the chromatography before an operation.

In such a separation chromatography supporting device, a method of clarifying a relationship between a solvent mixing ratio and an Rf value based on the result of TLC and thereby predicting the result of chromatography is adopted. Here, in PTL 1, prediction is performed on a premise that the relationship between the mixing ratio of each component in an eluent and mobility Rf of a sample is a proportional relationship, and that a change rate of the mobility Rf of the sample with respect to the mixing ratio of the component in the eluent is the same even though a type of the sample is changed.

In PTL 2, prediction is performed based on a relational formula different from that in PTL 1, and is performed on a premise that a change rate in the relational formula is the same even though a type of a sample is changed.

PTL 3 discloses that TLC is performed on at least two points in which solvent mixing ratios are different. However, it is preferable that accurate prediction can be performed by TLC on one point.

The premise that “a change rate of the mobility Rf of the sample with respect to the mixing ratio of each component in the eluent is the same even though a type of the sample is changed” in PTLs 1 and 2 is not absolutely correct, and is considered as an approximation method. That is, although a certain degree of accurate prediction can be performed based on such a premise, the relationship between the mobility Rf of the sample and the mixing ratio of each component in the eluent actually causes a certain degree of change due to a change in the type of the sample.

Therefore, when it is necessary to perform more accurate analysis, it is required to perform prediction with higher accuracy than that described in PTLs 1 and 2. In order to cope with such a case, an object of the present invention is to provide a method for predicting a result of chromatography with higher accuracy.

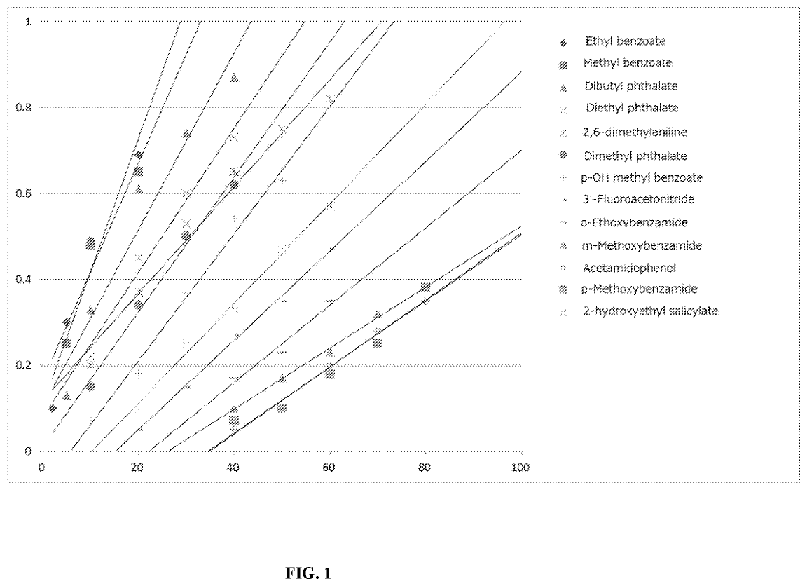

In order to describe the method according to the present invention, FIG. 1 is a graph showing a relationship between a solvent mixing ratio B and an Rf value when TLC is performed on plural compounds at various solvent mixing ratios. Based on results in FIG. 1, it is clear that there is a difference in a change rate of a mobility Rf of a sample with respect to a mixing ratio of each component in an eluent depending on a compound.

On the other hand, it can be seen that such a difference is large between a compound having a large Rf even though a nonpolar solvent is used and a compound having a small Rf unless a polar solvent is used, that is, a compound presenting as a straight line in a left direction on the graph in FIG. 1 and a compound presenting as a straight line in a right direction, and differences in the change rate of the mobility Rf of the sample with respect to the mixing ratio of each component in the eluent for adjacent compounds in the graph are relatively similar values. When the same analysis is performed based on a general formula (2) described below, the same tendency is observed.

The present invention is completed based on such a viewpoint. That is, when the relationship between the mixing ratio of each component in the eluent and the mobility Rf is expressed as

$$Rf = {a}_{1} B + {b}_{1} , \qquad ( 1 )$$

a₁ corresponds to the change rate of the mobility Rf of the sample with respect to the mixing ratio of each component in the eluent. In PTL 1, a calculation is performed assuming that a₁ is always a constant value. However, in the present invention, a value of a₁ in the general formula described above is acquired for a compound to be separated based on the result of TLC at a specific solvent mixing ratio corresponding to such a change in the value of a₁, whereby the result of chromatography can be predicted with higher accuracy.

Further, the same prediction can also be performed for a₂ in a relational formula of

$$log {k}^{′} = {a}_{2} log B + {b}_{2} \qquad ( 2 )$$

$$( where retention ratio : {k}^{′} = ( {t}_{R} - {t}_{0} ) / {t}_{0} \qquad ( 3 )$$

solvent ratio: B). In this case, it is also possible to predict the result of chromatography with higher accuracy by analyzing plural results of TLC using the same method.

Hereinafter, an example of a method for calculating a₁ and a₂ will be described in detail. The method for calculating a₁ and a₂ in the present invention is not limited to the method exemplified below. A case according to Formula (1) and a case according to Formula (2) will be described in detail below.

In the present description, B is the solvent mixing ratio, and is, for example, a value indicating a ratio of any one of solvents when liquid chromatography is performed in a mixed system including two types of solvents of X and Y. As any one of a molar fraction (mol %), a volume ratio (vol %), a weight ratio (wt %), and the like, the mixing ratio shows a certain correlation, and thus any one among these can be used. In the following example, experimental results with the molar fraction (mol %) serving as a reference are shown.

### (Approximation According to Formula (1))

First, data obtained by measuring Rf values of various compounds in a specific mixed solvent at various solvent mixing ratios is acquired. Rf can be obtained for various B in the same compound. The actually measured data is approximated as a linear expression. That is, for actually measured values of TLC, the relational formula of Rf=a₁B+b₁ is created for each compound. Then, such a measurement and formula creation are performed on many types of compounds. FIG. 1 is a graph showing obtained formulas with B as a horizontal axis and Rf as a vertical axis.

As is clear from FIG. 1, it is clear that a slope a₁ in the general formula described above is constant to a certain degree depending on a position of two-dimensional coordinates represented by the solvent mixing ratio B and Rf. It is preferable that, when a calculation formula for clarifying this relationship can be provided, a general formula closer to actual values can be obtained only by inputting the solvent mixing ratio B and Rf, and that a correlation between predicted separation and actual separation is high when column chromatography is performed using this general formula.

Further, all the calculation formulas corresponding to positions on the coordinates may be created at coordinates of Rf/B and stored, so that a calculation formula may be acquired by calling the calculation formula as required.

The method for calculating a₁ based on the results as shown in FIG. 1 is not particularly limited, and an example thereof will be described in detail below.

As is clear from FIG. 1, a value of a slope a is relatively large in a left region (that is, a region in which Rf is large while B is small) of the graph, and is relatively small in a right region (that is, a region in which Rf is small while B is large) of the graph.

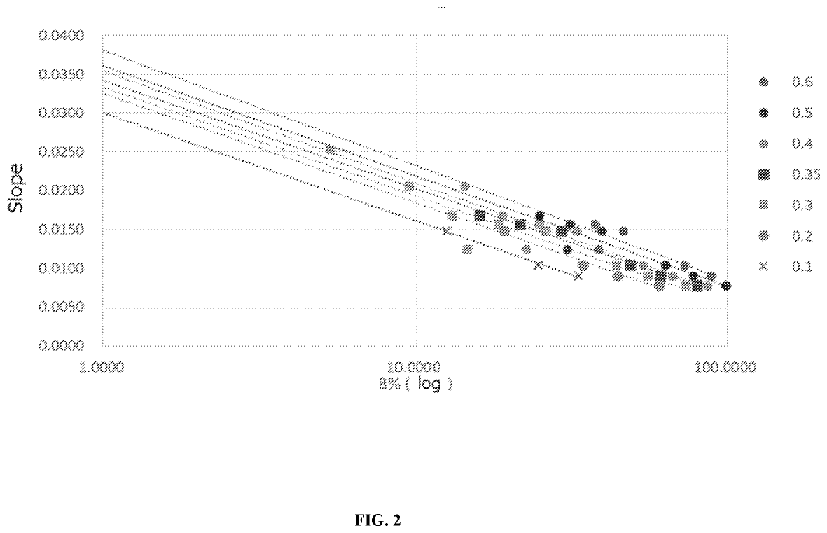

Therefore, for example, a relationship between each slope a₁ and B can be expressed when the Rf value is fixed. This is shown in FIG. 2. As is clear from FIG. 2, the relationship between the slope a₁ and B when a specific Rf value is used is clear.

That is, based on results in FIG. 2, a relational formula of

$${a}_{1} = d \times ln B + e \qquad ( 4 )$$

$$can be derived .$$

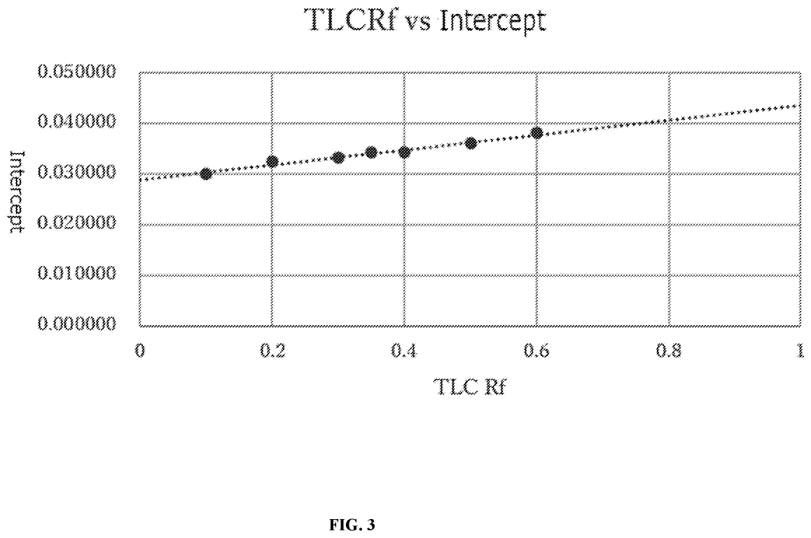

Further, as can be seen from FIG. 2, d in the general formula (4) described above is constant even when any Rf is used. On the other hand, e is a change caused by a difference in Rf. A relationship between Rf and an intercept e is shown in FIG. 3. It is shown from FIG. 3 that there is a proportional relationship between Rf and e, and this relationship can be expressed as e=g×Rf+h. Therefore, based on this relationship, the general formula (4) can be rewritten as

$${a}_{1} = d \times ln B + g \times Rf + h . \qquad ( 4 - 1 )$$

Since d, g, and h are constants determined by a type of a mixed solvent, a₁ can be calculated when B and Rf are measured.

By using the general formula (4) created in this way, it is possible to calculate a₁ with respect to B when a specific Rf value is used. Further, for many types of Rf values, a₁ may be calculated for any combination of Rf and B by preparing such a formula, and a₁ may be calculated based on actually measured values of Rf and B according to the general formula (4-1) described above.

Based on actually measured values for various compounds, a calculation formula for calculating a₁, such as the general formulas (4) and (4-1) as described above, is created in advance, and a₁ can be calculated by performing the above calculation by a calculation formula acquisition unit of the separation chromatography supporting device according to the present invention.

For example, TLC is performed on a compound to be separated at a specific solvent mixing ratio B, an Rf value is measured, and a₁ can be calculated according to the general formulas (4) and (4-1) based on the relationship between B and Rf. Further, the general formula (1) described above can also be created. The separation chromatography supporting device according to the present invention includes the calculation formula acquisition unit that creates the general formula (1).

By performing such processing, it is possible to obtain, for any point on a coordinate axis, the general formula (1) closer to actual results of the column chromatography than that in the related art. Further, in such processing, it is also not necessary to perform TLC a plurality of times.

In addition, for any point on the coordinate axis, the above formula (1) may be created according to the calculation formula described above or another method, all formulas may be stored in the calculation formula acquisition unit, and a calculation formula may be acquired by calling the calculation formula (1) corresponding to the input Rf value and B.

When separation column chromatography is performed on a sample containing a plurality of types of compounds, the formula (1) can be created for each of the plurality of compounds to be separated by the calculation formula acquisition unit described above. Based on the plurality of formulas (1) obtained in this way, results of column chromatography as described in detail below can be predicted.

### (Approximation According to Formula (2))

When approximation is performed based on Formula (2), it is possible to essentially perform a study using the same method as that in Formula (1) described above. The approximation is basically the same as that disclosed in PTL 2. In the present invention, when a result of chromatography is predicted based on the Formula (2), a value of a₂ is calculated based on a result of TLC rather than performing approximation on a premise that the slope a₂ is normally constant.

Therefore, mathematical processing similar to that performed on the general formula (1) described above is performed, and a calculation formula for calculating the value of a₂ corresponding to a specific Rf value is acquired using the same method, whereby the general formula (2) close to an actual situation can be created.

In the above aspect of the present invention, a retention force k′ is defined by the following formula (3)

$${k}^{′} = ( {t}_{R} - {t}_{0} ) / {t}_{0} . \qquad ( 3 )$$

Here, t₀ is time required for an elution solvent to pass through a specific column and is a value specific to the column determined by a size, a shape, and the like of the column, and t_{R} is an elution time required for a sample to be separated to pass through a specific column. Since to is a constant specific to the column, the elution time t_{R} when the specific column is used can be obtained by obtaining k′.

The retention force k′ and the solvent ratio B have a relationship expressed by the following formula (2)

$$log {k}^{′} = alogB + b . \qquad ( 2 )$$

In order to perform analysis based on the general formula (2), it is necessary to clarify a relationship between Rf, which is the result of TLC, and k′ described above. This point will be described in detail later. Generally, it is known that a relationship of t_{R}=t₀/Rf is established between Rf of thin-layer chromatography and t₀ and t_{R} of liquid chromatography. Therefore, when Rf is measured, a relationship between t₀ and t_{R} is clear, and k′ in the general formula described above is obtained by substituting the relationship between t₀ and t_{R} into the general formula (3).

Specifically, k′=(1/Rf)−1 is obtained. By performing the same processing as that performed on Formula (1) described above using this formula, a relational formula between a₂ and B is created for each k′. Then, these relational formulas are stored in the calculation formula acquisition unit. It is possible to obtain an appropriate Formula (2) based on the result of TLC using the same method as that in Formula (1) described above except that an approximate expression is different.

### (Correction for Difference Between TLC and Liquid Chromatography)

The general formulas (1) and (2) obtained by the above TLC may not completely coincide with a relational formula in liquid chromatography.

Therefore, a correction item for correcting such a deviation may be further added to the general formulas (1) and (2) described above. Such a correction item is not specifically limited, and the general formulas (1) and (2) can be corrected by acquiring data on separation by TLC and column chromatography and analyzing the data.

Further, when the general formulas (1) and (2) with respect to any combination of B and Rf as described above are stored, a calculation formula in consideration of the above deviation may be created in these calculation formulas and stored.

### (Type of Solvent in Mixed Solvent)

In separation column chromatography, when separation is performed with a mixed solvent using a plurality of types of solvents, several types of combinations of the solvents are conceivable. The relationship between B and Rf as described above is specific to a type of solvent to be used, and when the type of solvent is changed, a formula to be used when the general formulas (1) and (2) are calculated is also different.

Therefore, in the separation chromatography supporting device according to the present invention, a plurality of types of data for a combination of a plurality of types of solvents may be stored as the calculation formula acquisition unit for a₁ and a₂ as described above. In this case, an analysis based on a result of TLC as described above can be performed on each combination of solvents, a general formula can be created and stored in the calculation formula acquisition unit. In this way, the number of types of operations that can be supported by the separation chromatography supporting device according to the present invention is greatly increased, and utility is improved.

Such a combination of solvents is not particularly limited, and a combination of a nonpolar solvent and a polar solvent is preferable. More preferable examples thereof include hexane/ethyl acetate, hexane/chloroform, chloroform/methanol, ethyl acetate/methanol, hexane/dichloromethane, and dichloromethane/methanol. Depending on properties of a compound to be separated, an appropriate combination of solvents can be selected from these combinations and used.

### (Gradient)

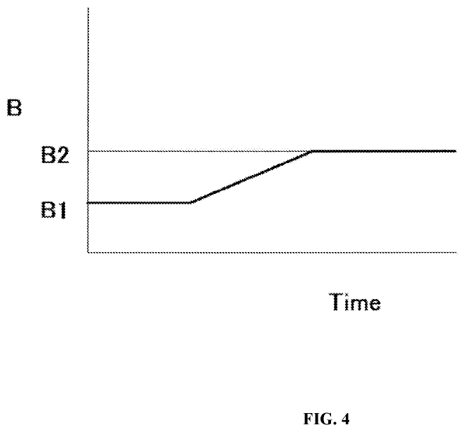

A gradient pattern refers to a change pattern in which a solvent mixing ratio changes with time and a gradient is performed when liquid chromatography is performed. For example, this means what is shown in FIG. 4. To perform the gradient itself is a general-purpose method for liquid chromatography.

When the relational formula of the general formula (1) or the general formula (2) is clear, it is possible to predict an elution state when the gradient is performed using a known method as described in, for example, PTLs 2 and 3. Accordingly, it is possible to predict an elution curve when separation column chromatography is actually performed.

Accordingly, since an elution time of a sample can be calculated based on a mixing ratio of an eluent or a gradient pattern of the mixing ratio of the eluent, it can be determined in advance whether separation by liquid chromatography can be achieved. Thus, based on the calculation result, it is possible to select an optimum mixing ratio of the eluent or an optimum gradient pattern of the mixing ratio of the eluent that enables sufficient separation.

### (Configuration of Invention)

The present invention provides a separation chromatography supporting device, and provides a calculation formula useful for performing separation chromatography by the calculation formula acquisition unit described above. When such a separation chromatography supporting device is actually applied to liquid chromatography, preferable aspects of the device include a liquid chromatography control device, a method for performing liquid chromatography, and a liquid chromatography control program.

Such a separation chromatography supporting device according to the present invention preferably uses a computer. A computer that stores calculation formulas or programs for performing the above processing is preferably used. Further, a computer that stores programs for performing such processing on a server using a network, accesses to such programs from a client, and performs processing may be used.

Hereinafter, each unit will be described in detail.

### (Actually Measured Value Storage Unit)

An actually measured value storage unit is a unit that stores results of thin-layer chromatography.

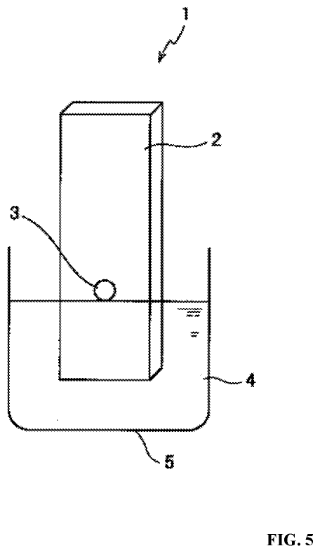

FIG. 5 shows a TLC device 1 used in thin-layer chromatography (TLC). The TLC device 1 includes a silica gel thin-layer plate 2 having a surface on which a sample 3 is dropped, and an eluent 4 stored in a container 5. In addition, the sample 3 and silica gel for forming the silica gel thin-layer plate 2 is the same as that used in liquid chromatography to be described later.

Further, the eluent 4 to be used is a solvent in the same solvent system as that used in the liquid chromatography, and uses a mixed solvent.

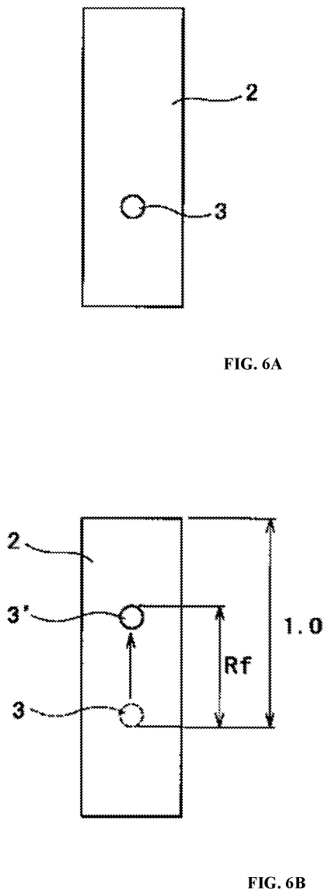

In TLC, first, as shown in FIG. 5, the silica gel thin-layer plate 2 in a state in which the sample 3 is dropped is immersed in the eluent 4 as shown in FIG. 1. Then, the eluent 4 is suctioned into the silica gel thin-layer plate 2 due to capillary action. Accordingly, the sample 3 is also moved upward. When movements of the eluent 4 and the sample 3 are stopped, as shown in FIG. 6B, the sample 3 moves to a position of a sample 3′. At this time, a distance from a position of the sample 3 before being immersed in the eluent 4 to an upper end of the eluent 4 is set to 1.0, and a distance to the sample 3′ with respect to 1.0 is obtained as the mobility Rf (FIGS. 6A and 6B).

In this case, an operator may read an Rf value from the thin-layer plate after measurement and input the value as a numerical value, or a thin-layer chromatography plate may be placed at a predetermined position of the device and the Rf value may be automatically read based on image analysis. In spot analysis, it is possible to adopt a method for reading a spot position by emitting detection light such as ultraviolet rays as necessary and utilizing light emission generated by the detection light.

The actually measured value storage unit is a unit that stores the Rf value obtained by the thin-layer chromatography in association with the solvent mixing ratio B. The values stored in this way are used in the calculation formula acquisition unit below.

### (Calculation Formula Acquisition Unit)

The calculation formula acquisition unit in the present invention is a unit that creates the general formula (1) for a specific component with respect to a specific solvent system based on the result of the above thin-layer chromatography. The calculation formula is described above in detail.

### (Liquid Chromatography Result Prediction Unit)

When the general formula (1) or the general formula (2) is determined for all samples that are required to be separated, a mixing ratio of an eluent and an elution time corresponding to a column to be used can be predicted. Based on this, an operator can easily estimate a favorable solvent mixing ratio.

Further, when a specific liquid chromatography condition (for example, a sample amount) is input, an elution time corresponding to the liquid chromatography condition can also be presented. Further, it is also possible to display a separation degree Rs or an expected elution curve. The operator can easily determine quality of a plurality of types of liquid chromatography conditions by viewing these pieces of information. Accordingly, it is possible to easily select an optimum liquid chromatography condition (solvent mixing ratio, column to be used, and the like) before an experiment.

A result of liquid chromatography can be predicted by a normal computer, and results thereof can be displayed on a general display device represented by various displays.

The elution time in the liquid chromatography can be calculated according to methods described in the related art as described in PTLs 2 to 4. By combining the method according to the present invention and the methods described in the patent literatures, predictions can be performed more accurately and a preferable method is obtained.

As presentations of the liquid chromatography result prediction, the elution time and the separation degree may be shown as specific numerical values in an image, and the elution curve may be displayed. By comparing these values corresponding to several measurement conditions, the operator can learn an optimum liquid chromatography method.

When the chromatography conditions are determined, column selection is also an important factor. As described above, a sample load amount is also an important factor in the column selection. That is, when the amount of the sample to be separated is large, a larger column is required. Information necessary for such a purpose may be displayed in an image.

### (Liquid Chromatography Condition Determination Unit)

In the present invention, the operator evaluates the liquid chromatography conditions created by himself or herself or recommended by a device while using the liquid chromatography result prediction unit, and finally determines the liquid chromatography conditions.

### (Mixing Ratio Control Unit)

In the present invention, liquid chromatography may be performed based on determination performed by a liquid chromatography condition determination unit. A mixing ratio control unit is a unit that outputs, based on a liquid chromatography condition selected by the operator based on the liquid chromatography condition determination unit, a control signal for controlling a mixing ratio of an eluent to be sent to a column or a gradient pattern of the mixing ratio of the eluent. As the mixing ratio control unit, a known unit can be used.

### (Liquid Chromatography Control Device)

Hereinafter, an example of an aspect of the liquid chromatography control device according to the present invention will be described in more detail with reference to the drawings. The present invention is not limited to contents described in the following drawings. The present invention may relate to a liquid chromatography apparatus including necessary elements and a control device that controls liquid chromatography by the above units using a computer that controls the liquid chromatography apparatus. An example of an aspect in which the above method is used when an actual apparatus is operated will be described below in detail.

In the present invention, a gradient condition for general-purpose liquid chromatography may be stored as a library, and the computer may automatically select a gradient pattern of a recommended mixing ratio of an eluent or a recommended gradient pattern of the mixing ratio of the eluent from the library based on a result of the general formulas (1) and (2) for each component, and the gradient pattern may be recommended to an operator. The operator may determine a liquid chromatography condition in a manner of approving a recommended condition.

When the chromatography condition is determined, column selection is also an important factor. Therefore, for t₀, it is also preferable that to corresponding to each column used in the liquid chromatography is stored in the liquid chromatography result prediction unit, and that a corresponding value of t₀ is called when the operator selects a column. In addition, as necessary, a function of manually inputting t₀ may be provided.

In the present invention, the operator evaluates the liquid chromatography condition created by himself or herself or recommended by a device while using the liquid chromatography result prediction unit, and finally determines the liquid chromatography condition.

### (Mixing Ratio Control Unit)

In the present invention, liquid chromatography is performed based on the determination by the liquid chromatography condition determination unit described above. A mixing ratio control unit is a unit that outputs, based on a liquid chromatography condition selected by the operator based on the liquid chromatography condition determination unit, a control signal for controlling a mixing ratio of an eluent to be sent to a column or a gradient pattern of the mixing ratio of the eluent. As a mixing ratio control unit, a known unit can be use, and for example, a unit as disclosed in PTL 1 can be used.

### (Liquid Chromatography Control Device)

Hereinafter, an example of an aspect of the liquid chromatography control device according to the present invention will be described in more detail with reference to the drawings. The present invention is not limited to contents described in the following drawings. The present invention relates to a liquid chromatography apparatus including necessary elements and a control device that controls liquid chromatography by the above units using a computer that controls the liquid chromatography apparatus. An example of an aspect in which the above method is used when an actual device is operated will be described below in detail.

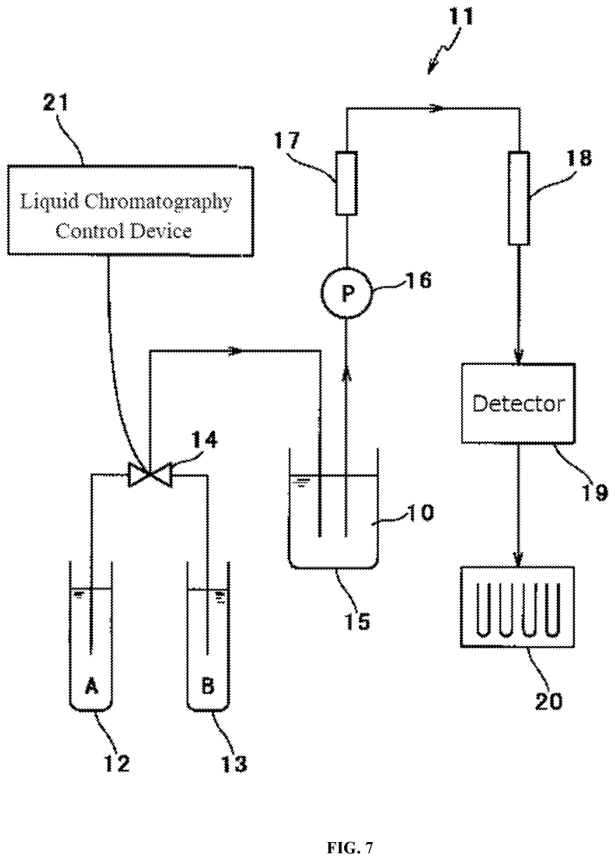

FIG. 7 shows a liquid chromatography device 11. In the liquid chromatography device 11, a path is formed by an arrangement in an order of a container 12 in which a solvent A is stored, a container 13 in which a solvent B is stored, a solenoid valve 14 provided at a position at which the solvent A and the solvent B are connected, a mixer 15 in which a mixed solvent 10 is stored, a pump 16, an injector 17, a column 18, a detector 19, and a fraction collector 20. A liquid chromatography control device 21 is connected to the solenoid valve 14.

The solvent A is stored in the container 12, and the solvent B is stored in the container 13. In addition, a solvent to be used is not limited to two types, and the number of types thereof may increase depending on a use state and a purpose. In general, a combination of nonpolar molecules and polar molecules is used for the solvent A and the solvent B.

The pump 16 pumps up the solvent A and the solvent B via the container 15 and the solenoid valve 14 in the path of the liquid chromatography device 11. The solenoid valve 14 selects a solvent to be pumped up from the solvent A and the solvent B according to a control signal from the liquid chromatography control device 21. A mixing ratio of the solvents A and B in the mixer 15 is determined according to time for selecting each solvent by the solenoid valve 14. In the mixer 15, the pumped-up solvents A and B are temporarily stored and used as the mixed solvent 10. The mixed solvent 10 has a calculated mixing ratio as described later.

The injector 17 contains the sample 3, and the sample 3 is sent out by the mixed solvent 10 passing through the injector 17. In addition, the number of injectors 17 is not limited to one, and it is also possible to continuously operate a plurality of samples by arranging a plurality of injectors side by side so as to be selectable in path selection.

The column 18 is filled with a stationary phase, and liquid chromatography is performed by the mixed solvent 10 passing through the stationary phase. Silica gel for forming the silica gel thin-layer plate 2 as shown in FIG. 5 is used as the stationary phase. In addition, the number of columns is not limited to one, and it is also possible to perform a plurality of types of liquid chromatography by arranging a plurality of columns side by side so as to be selectable in path selection.

The detector 19 detects a result of the liquid chromatography performed in the column 18. The fraction collector 20 includes a plurality of test tubes, and, based on an analysis result of the detector 19, components contained in the sample 3 are separated into the test tubes respectively.

The liquid chromatography control device according to the present invention is a device for controlling the liquid chromatography as shown in FIG. 7, and is preferably a computer including the actually measured value storage unit, the calculation formula acquisition unit, the liquid chromatography result prediction unit, the liquid chromatography condition determination unit, and the mixing ratio control unit as described above in an internal hard disk, or a client computer connected to a server that stores information necessary for operating these units.

Accordingly, the liquid chromatography is favorably performed by performing calculation as described above and controlling the liquid chromatography.

### Example

Hereinafter, the present invention will be described in more detail with reference to an example.

### (Method for Calculating a₁ Based on TLC Measurement)

A plurality of types of mixed solvents containing B % by weight of X with respect to a mixed weight of X and Y were prepared as two specific types of solvents, then TLC was performed on 13 types of compounds with respect to the plurality of types of mixed solvents having different ratios of B, and a relational formula of

$$Rf = {a}_{1} B + {b}_{1} \qquad ( 1 )$$

was clarified for each of the compounds. The calculated general formulas (1) for the 13 types of compounds were shown on a graph in FIG. 1.

Further, based on FIG. 1 and the general formulas, a₁ was read when Rf=0.1, 0.2, 0.3, 0.35, 0.4, 0.5, and 0.6, and a relationship between each a obtained in this manner and log B was shown in FIG. 2. According to FIG. 2, a₁ and log B can be linearly approximated, and a relational formula indicating the relationship between each a₁ and log B can be obtained for each of the Rf values.

For each of the Rf values obtained in this manner, the relational formula indicating the relationship between a₁ and log B was created using the method described above and stored in a computer. Accordingly, when Rf and B were input, a corresponding general formula (1) was called.

A separation chromatography experiment was performed using a separation chromatography supporting device prepared in this manner.

In the experiment, a test sample obtained by mixing three types of compounds was used. TLC measurement was performed on one point using a specific mixed solvent B. Then, based on this, the general formula (1) was created for the three types of compounds, whereby an elution curve was predicted for several recommended gradient patterns. An optimum result was selected from these results, and separation chromatography was performed accordingly. In order to perform separation chromatography, the device as shown in FIG. 7 was used. Further, detection by a detector was performed while the separation was performed, and an elution curve was created while the separation was performed.

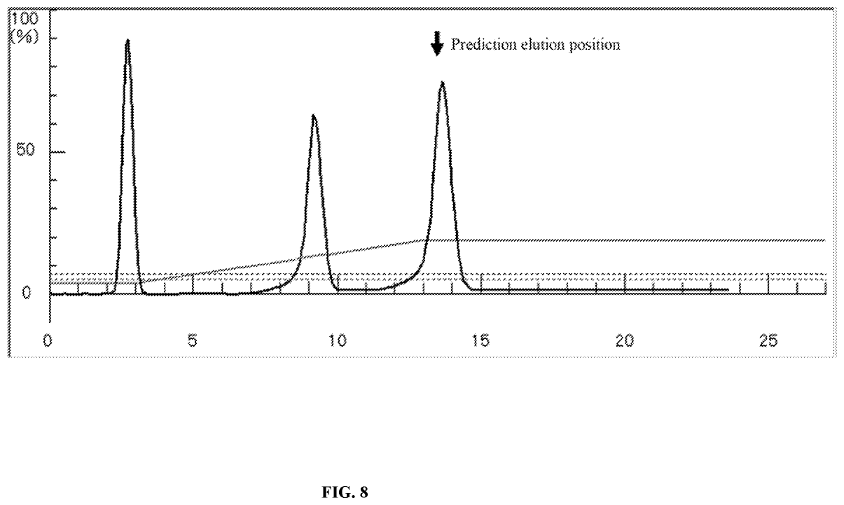

The results were shown in FIG. 8. In FIG. 8, a horizontal axis represents time (minute), and a vertical axis represents peak intensity. Further, FIG. 8 shows a predicted elution time of a final compound when the prediction was performed using the relational formula (1) obtained by the separation chromatography supporting device according to the present invention. Based on this result, it is clear that the compound to be separated is eluted at an elution time close to an expected elution time.

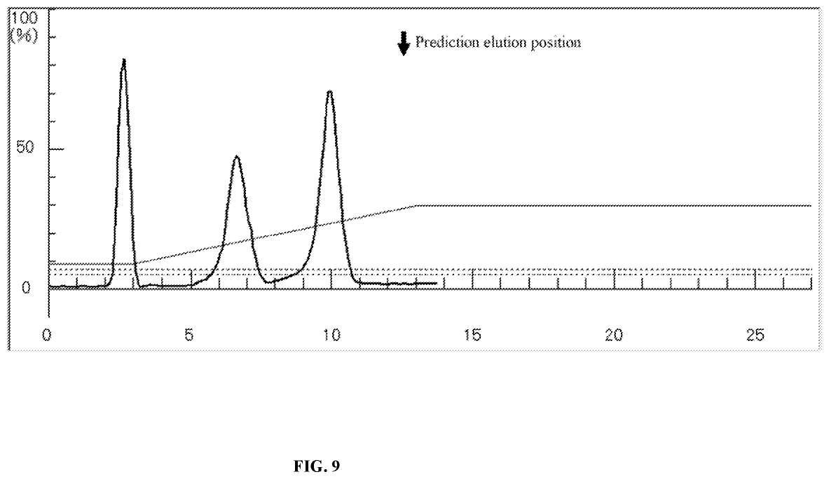

As described in PTL 1, the same experiment was performed based on the result of TLC and based on a fixed value of a₁. The results are shown in FIG. 9.

When these results are compared, there is a difference in the expected value of the elution time. When actual separation column chromatography was performed, a prediction result based on the separation chromatography supporting device according to the present invention was close to a result of the separation column chromatography. Therefore, the separation chromatography supporting device according to the present invention has more excellent performance than devices in the related art.

The separation chromatography supporting device according to the present invention can be suitably used in the separation chromatography in studies of a chemical field.

### PARTS LIST

1 TLC device
2 silica gel thin-layer plate
3 sample
4 eluent
5 container
11 liquid chromatography device
12, 13 container
14 solenoid valve
15 mixer
16 pump
17 injector
18 column
20 fraction collector

What is claimed is:

1. A separation chromatography supporting device comprising:
a calculation formula acquisition unit, wherein
the separation chromatography supporting device provides information related to separation in column chromatography based on an actually measured value of an Rf value when a mixed solvent having a mixing ratio B of two specific types of solvents measured by thin-layer chromatography or liquid chromatography is used, and
the calculation formula acquisition unit acquires a₁ in a relational formula of
$$Rf = {a}_{1} B + {b}_{1} \qquad ( 1 )$$
$$or {a}_{2} in a relational formula of$$
$$log {k}^{′} = {a}_{2} logB + {b}_{2} \qquad ( 2 )$$
$$( where retention ratio : {k}^{′} = ( {t}_{R} - {t}_{0} ) / {t}_{0} \qquad ( 3 )$$
solvent ratio: B) based on B and Rf that are actually measured values as one measurement result by TLC.

2. The separation chromatography supporting device according to claim 1, further comprising:
a calculation formula acquisition unit configured to actually measure a relationship between Rf values of plural types of compounds and a mixing ratio B of a solvent for a combination of two specific types of solvents, the calculation formula acquisition unit being obtained based on data obtained in the measurement.

3. A separation chromatography apparatus comprising:
the separation chromatography supporting device according to claim 1 or 2.

4. A separation chromatography method comprising:
a step (1) of performing thin-layer chromatography on a compound to be separated in a mixed solvent having a mixing ratio B of two specific types of solvents;
a step (2) of inputting an Rf value and the mixing ratio B obtained in step (1) into the separation chromatography supporting device according to claim 1;
a step (3) of acquiring, based on data input in step (2), a₁ or a₂ in a relational formula of
$$Rf = {a}_{1} B + b \qquad ( 1 )$$
$$or$$
$$log {k}^{′} = {a}_{2} logB + b \qquad ( 2 )$$
$$( where retention ratio : {k}^{′} = ( {t}_{R} - {t}_{0} ) / {t}_{0} ) ; \qquad ( 3 )$$
a step (4) of determining a gradient condition for separation chromatography based on the relational formula; and
a step (5) of performing chromatography according to the gradient condition determined in step (4).
